(19) United States
(12) Patent Application Publication
(10) Pub. No.: US 2025/0256657 A1
(43) Pub. Date: Aug. 14, 2025

(54) QUICK LATCH MECHANISM

(71) Applicant: Rivian IP Holdings, LLC, Irvine, CA (US)

(72) Inventors: Leo Henrik Takahashi-Planck-Prideaux, Austin, TX (US); Michal Jan Holcer, Mission Viejo, CA (US); Rachel Esther Gitajn, San Clemente, CA (US); Austin Lee Frederickson, Carlsbad, CA (US); Mohamad Jeffery Hammoud, Bloomfield Hills, MI (US)

(73) Assignee: Rivian IP Holdings, LLC, Irvine, CA (US)

(21) Appl. No.: 19/052,954

(22) Filed: Feb. 13, 2025

Related U.S. Application Data
(60) Provisional application No. 63/553,405, filed on Feb. 14, 2024.

(51) Int. Cl. B60R 9/10

(52) U.S. Cl. CPC B60R 9/10

(57) ABSTRACT

An apparatus can include a body. The body can couple with a mounting mechanism. The apparatus can also include an adjustment assembly. The adjustment assembly can couple with the body. The adjustment assembly can adjust an orientation of an object receiving surface. The object receiving surface can couple with the adjustment assembly. The object receiving surface can receive an object. The object receiving surface can at least partially surround the object.

### CROSS-REFERENCE TO RELATED PATENT APPLICATIONS

This application claims the benefit of and priority to U.S. Provisional Patent Application No. 63/553,405, filed on Feb. 14, 2024, the entirety of which is incorporated by reference herein.

### INTRODUCTION

Vehicles can carry or transport equipment.

### SUMMARY

This disclosure is generally related to one or more components of a vehicle. The components can include at least one apparatus. The apparatus can include at least one of a body or an adjustment assembly. The apparatus can include at least one of the quick latch mechanism or the quick attachment mechanism described herein. The apparatus can be included with the vehicle. For example, the apparatus can be provided with the vehicle. The body can couple with a mounting mechanism. For example, the body can couple with a bike rack of a vehicle. The adjustment assembly can adjust an orientation of a surface. For example, the adjustment assembly can adjust an orientation of an object receiving surface.

At least one aspect is directed to an apparatus. The apparatus can include a body. The body can couple with a mounting mechanism. The apparatus can also include an adjustment assembly. The adjustment assembly can couple with the body. The adjustment assembly can adjust an orientation of an object receiving surface. The apparatus can also include the object receiving surface. The object receiving can be coupled with the adjustment assembly. The object receiving surface can receive an object. The object receiving surface can at least partially surround the object.

At least one aspect is directed to a vehicle. The vehicle can include an apparatus. The apparatus can include a body. The body can couple with a mounting mechanism. The apparatus can also include an adjustment assembly. The adjustment assembly can couple with the body. The adjustment assembly can adjust an orientation of an object receiving surface. The apparatus can also include the object receiving surface. The object receiving surface can be coupled with the adjustment assembly. The object receiving surface can receive an object. The object receiving surface can at least partially surround the object responsive to receipt of the object.

At least one aspect is directed to a method. The method can include coupling a body of an apparatus with an adjustment assembly of the apparatus. The body can couple with a mounting mechanism. The adjustment assembly can adjust an orientation of an object receiving surface of the apparatus. The object receiving surface can receive an object. The object receiving surface can also at least partially surround the object responsive to receipt of the object.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, in accordance with an implementation.

FIG. 2 depicts a perspective view of an apparatus, in accordance with an implementation.

FIG. 3 depicts a perspective view of an attachment mechanism, in accordance with an implementation.

FIG. 4 depicts a perspective view of an apparatus, in accordance with an implementation.

FIG. 5 depicts a perspective view of the apparatus illustrated in FIG. 4, in accordance with an implementation.

FIG. 6 depicts a perspective view of the apparatus illustrated in FIG. 4, in accordance with an implementation.

FIG. 7 depicts a perspective view of the apparatus illustrated in FIG. 4, in accordance with an implementation.

FIG. 8 depicts a perspective view of a mounting mechanism including the apparatus illustrated in FIG. 4, in accordance with an implementation.

FIG. 9 depicts a perspective view of a mounting mechanism including the apparatus illustrated in FIG. 4, in accordance with an implementation.

FIG. 10A depicts a block diagram of a process to manufacture the apparatus illustrated in FIG. 4, in accordance with an implementation.

FIG. 10B depicts a block diagram of a process to manufacture the apparatus illustrated in FIG. 4, in accordance with an implementation.

FIG. 11 depicts a perspective view of a vehicle including the attachment mechanism illustrated in FIG. 3, in accordance with an implementation.

FIG. 12 depicts a perspective view of a vehicle including the attachment mechanism illustrated in FIG. 3, in accordance with an implementation.

FIG. 13 depicts a perspective view of a vehicle including the attachment mechanism illustrated in FIG. 3, in accordance with an implementation.

FIG. 14 depicts a perspective view of a vehicle including the attachment mechanism illustrated in FIG. 3, in accordance with an implementation.

FIG. 15 depicts a perspective view of a vehicle including the attachment mechanism illustrated in FIG. 3, in accordance with an implementation.

FIG. 16 depicts a perspective view of a vehicle including the attachment mechanism illustrated in FIG. 3, in accordance with an implementation.

FIG. 17 depicts a perspective view of a vehicle including the attachment mechanism illustrated in FIG. 3, in accordance with an implementation.

FIG. 18 depicts a perspective view of a vehicle including the attachment mechanism illustrated in FIG. 3, in accordance with an implementation.

FIG. 19 depicts a perspective of a vehicle including the attachment mechanism illustrated in FIG. 3, in accordance with an implementation.

FIG. 20 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of a quick latch mechanism. The various concepts introduced above and discussed in greater detail below may be implemented in any of numerous ways.

The present disclosure is directed to systems and methods of one or more components for a vehicle. The components can include the quick latch mechanism. The quick latch mechanism can be provided with an apparatus. The apparatus can include a body. The body can couple with a vehicle. For example, the body can couple with the vehicle via a mounting mechanism. The mounting mechanism can include at least one of a bike rack, a bike stand, a bumper port, an attachment mechanism, or a structural member of a vehicle.

The apparatus can also include an adjustment assembly. The adjustment assembly can couple with the body. For example, the adjustment assembly can be mounted, secured, attached, or affixed with the body. The adjustment assembly can adjust an orientation of a surface. For example, the adjustment assembly can adjust an orientation of a surface to receive an object. The surface can move or adjust relative to the body or the adjustment assembly. For example, the surface can include an over-centering mechanism. As another example, the surface can move or collapse within a void of the body.

Other attachment mechanism can include metal or abrasive surfaces. For example, attachment mechanisms for other bike racks can include a metal attachment that couples with a bike. The metal attachment can rub or slide relative to the bike.

The disclosed solutions have a technical advantage of providing the quick latch mechanism with an over-centering surface that includes elastomer. The surface can surround an object (e.g., a bike) and as the surface surrounds the bike, the surface can deform around the bike. The elastomer included with the surface can provide a soft surface for the bike to rest on. The surface can secure the bike with the quick latch mechanism responsive to the surface surrounding, enclosing, or receiving the bike.

Systems and methods of the present technical solution also include providing an adjustment assembly. The adjustment assembly can couple the surface with the body of the apparatus. The adjustment assembly can adjust an orientation of the surface. For example, the adjustment assembly can rotate, pivot, swivel, or move the surface relative to the body of the apparatus. The adjustment of the surface, via the adjustment assembly, provides one or more configuration or placements for the surface. The surface can accommodate or receive objects of various sizes or arrangements based on the configurations. For example, a first bike and a second bike can include frames of varying slope. To continue this example, the surface can adjust, via the adjustment assembly, from a first angle (e.g., configuration, orientation, placement) to a second angle (e.g., configuration, orientation, placement) to accommodate the first bike or the second bike. The apparatus can also include a locking mechanism to lock or maintain a given position of the surface. For example, the surface can be in a first position and the locking mechanism can restrict movement of the surface to maintain the surface in the first position.

Some of the present technical solutions also include the movement or adjustment of the components of the quick latch mechanism. For example, the surface can move relative to the body. As another example, the surface can receive an object without the use of tools or equipment. The surface can move responsive to the surface receiving an object. For example, a placement of a bike or bike frame on the surface can cause the surface to wrap around or enclose the bike. As the bike frame is subsequently pressed down onto the surface, the surface can continue to wrap around the bike frame.

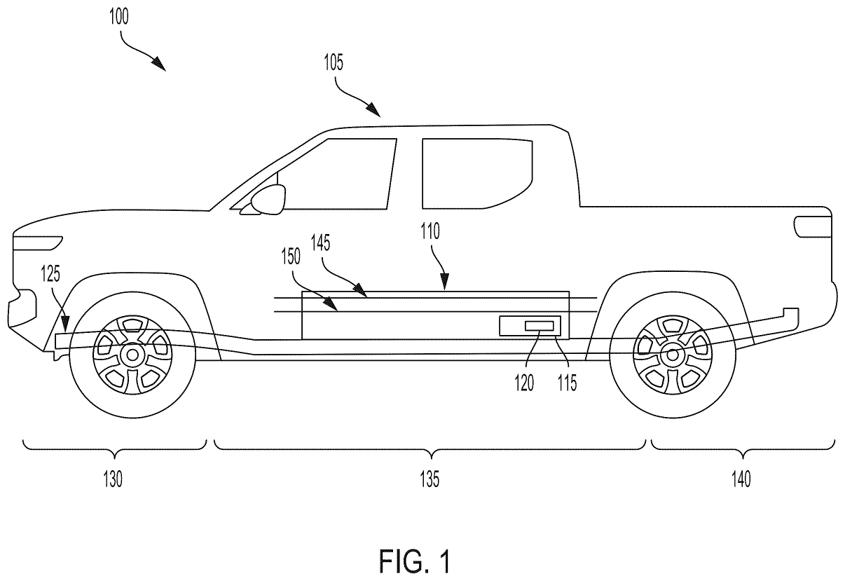

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

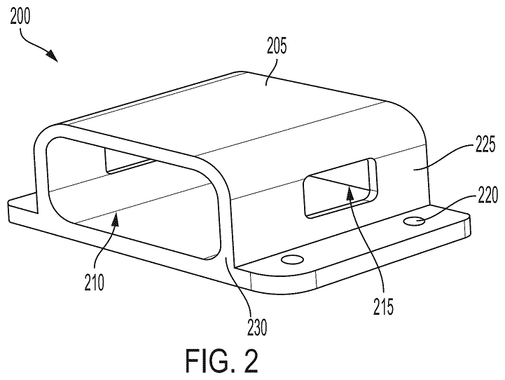

FIG. 2 depicts a perspective view of an apparatus 200. The apparatus 200 can include the apparatus described herein. For example, the apparatus 200 can provide at least one of the technical solutions described herein. The apparatus 200 can be coupled with a vehicle. For example, the apparatus 200 can be coupled with the vehicle 105. The apparatus 200 can be coupled with the vehicle 105 by at least one of attaching, mounting, securing, or connecting the apparatus 200 with the vehicle 105. For example, the apparatus 200 can be coupled with the chassis 125 of the vehicle 105. As another example, the apparatus 200 can couple with a crossbar of the vehicle 105.

The apparatus 200 can include at least one structural support attachment 205. The structural support attachment 205 can include the structural support attachment described herein. The structural support attachment 205 can interface with, engage with, or otherwise interact with at least one of the various components described herein. For example, the structural support attachment 205 can engage with the attachment mechanism described herein. The structural support attachment 205 can couple with a vehicle. For example, the structural support attachment 205 can couple with the vehicle 105.

The structural support attachment 205 can include a bumper port 205. The bumper port 205 can be coupled with the vehicle 105. For example, the bumper port 205 can be attached to the vehicle 105 via one or more fasteners. The bumper port 205 can be disposed within a portion of the vehicle 105. For example, the bumper port 205 can be placed or located within a rear bumper of the vehicle 105. Stated otherwise, the bumper port 205 can be disposed within a portion of the vehicle 105 that is located proximate to the rear of the vehicle 105 (e.g., a rear bumper or a rear portion). As another example, the bumper port 205 can be located in one or more positions of the vehicle 105, such as the roof of the vehicle 105, the tailgate of the vehicle 105, the liftgate of the vehicle 105, a door of the vehicle 105, or a top portion of the vehicle 105.

The bumper port 205 can include at least one opening 210, at least one aperture 215, at least one slot 220, and at least one housing 230. The opening 210 can define or otherwise establish a body, a housing, or an assembly of the bumper port 205. For example, the opening 210 can define the housing 230. The opening 210 can receive the attachment mechanism described herein. For example, the protruded portion of the attachment mechanism can be inserted into the opening 210. The opening 210 can provide access to the housing 230. For example, the opening 210 can provide a void or a cavity for the body of the attachment mechanism to be inserted into. The opening 210 can position at least a portion of the body within a portion of the vehicle. For example, the opening 210 can position the body of the attachment mechanism within the bumper of the vehicle 105.

The bumper port 205 can engage with the attachment mechanism. For example, the bumper port 205 can engage with the body of the attachment mechanism responsive to a spring-load block wedge applying a load to the bumper port 205. Stated otherwise, the body of the attachment mechanism can connect or interface with the bumper port 205. The housing 230 can include at least one face 225. For example, the housing 230 can include a first face 225 and a second face 225. The faces 225 can include the apertures 215. For example, the first face 225 can include a first aperture 215 and the second face 225 can include a second aperture 215. The apertures 215 can be located or disposed within the faces 225. For example, the apertures 215 can define a gap or a hole within the faces 225.

The apertures 215 can receive at least one of the various components described herein. For example, the apertures 215 can receive the pawls (e.g., a protrusion) described herein. The apertures 215 can provide an opening, a hole, or a gap to allow the pawls to escape or otherwise exist the housing 230 of the bumper port 205. The slots 220 can receive at least one fastener. For example, the slots 220 can receive a bolt or a screw. The slots 220 can couple the bumper port 205 with the vehicle 105 responsive to the slots receiving at least one fastener.

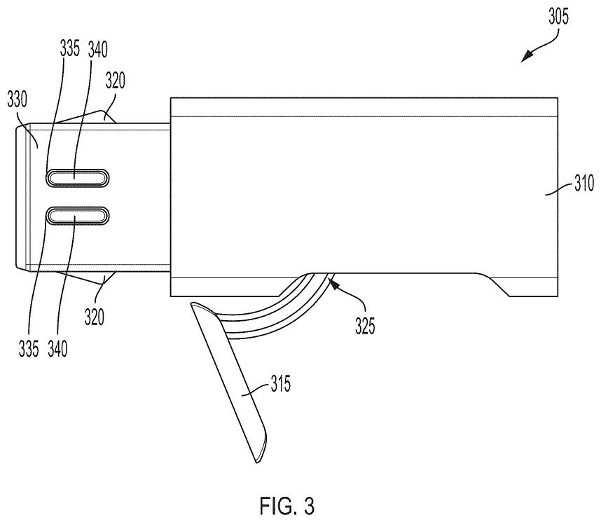

FIG. 3 depicts a perspective view of an attachment mechanism 305. The attachment mechanism 305 can include the attachment mechanism described herein. The attachment mechanism 305 can include the bumper port attachment. The apparatus 200 can include the attachment mechanism 305. The attachment mechanism 305 can include at least on body 310, at least one lever 315, at least one arm 325, at least one pawl 320, at least one portion 330, at least one opening 335, and at least one protrusion 340. The body 310 can include the body described herein. For example, the bumper port 205 can engage with the body 310. The body 310 can include the portion 330. The body 310 or a portion thereof can be inserted into the bumper port 205. For example, the portion 330 can be inserted into the opening 210. The body 310 can include a first portion 330 and a second portion 330. For example, as shown in FIG. 2 the portion 330 protrudes or extends beyond the body 310.

The body 310 can insert within the opening 210. For example, the portion 330 of the attachment mechanism 305 or the body 310 can be placed, located, or otherwise positioned within the opening 210. The body 310 can couple with the bumper port 205 without a rotational force. For example, the body 310 can couple with the bumper port 205 without spinning, twisting, hinging, or otherwise rotating the body 310. The body 310 can couple with the bumper port 205 via a single plane relative to the vehicle. For example, the body 310 can be inserted into the bumper port 205 by applying force within a single plane or direction. The opening 210 can receive at least a portion of the body 310. For example, the body 310 can include the portion 330 and the portion 330 can be inserted into the opening 210 (e.g., the opening 210 receives at least a portion of the body 310).

The lever 315 can couple the body 310 with the bumper port 205. For example, the lever 315 can activate, move, or engage the protrusions 340 to have the protrusions 340 contact the bumper port 205. Stated otherwise the lever 315 can couple the body 310 with the bumper port 205 using the protrusions 340. The body 310 can support a tray that is external to the vehicle 105. For example, the body 310 can support a beam (e.g., a tray) responsive to the lever 315 coupling the body 310 with the bumper port 205. The tray can include at least one of a storage compartment, a tote, a cabinet, a chest, a shelf, a bench, a beam, a board, a cooler, a dresser, a surface top, or other possible storage devices. The lever 315 can be coupled with the arm 325. For example, the lever 315 can be attached, secured, or otherwise mounted to the arm 325.

The lever 315 can include at least one position. For example, the lever 315 can include a first position and a second position. At least one position of the lever 315 can include an unlocked position. FIG. 3 depicts an example of the lever 315 in an unlocked position. At least one position of the lever 315 can include a locked position. The lever 315 can move from a first position to a second position. For example, force can be applied to pivot, swing, twist, rotate, or otherwise adjust a position of the lever 315. The lever 315 can move between positions to reversibly couple the body 310 with the bumper port 205. For example, the body 310 can be coupled with the bumper port 205 with the lever 315 in a first position and the body 310 can be decoupled with the bumper port 205 with the lever 315 in a second position.

The protrusion 340 can be disposed or otherwise located proximate to the opening 335. The protrusion 340 can be coupled with the arm 325. For example, the protrusion 340 can be attached, secured, or mounted to the arm 325. The lever 315 can control or otherwise move the protrusions 340. For example, the lever 315 can move the protrusions 340 from a first position to a second position. The lever 315 can move the protrusions 340 from a position within the body 310 to a position at least partially external to the body 310. For example, the lever 315 can move the protrusions 340 to cause the protrusions 340 to escape from the body 310 via the openings 335. The protrusions 340 can contact at least a portion of the bumper port 205. For example, the protrusions 340 can contact an internal portion of the housing 230. The protrusions 340 can contact the bumper port 205 with the protrusions 340 in a position that is external to the openings 335. The bumper port 205 can engage with the body 310 responsive to the protrusions 340 making contact with the housing 230.

The pawls 320 can escape the housing 230 via the apertures 215. For example, the pawls 320 can align with and/or otherwise be placed proximate to the apertures 215 responsive to the body 310 or the portion 330 having been inserted into the housing 230. The pawls 320 can secure or lock the body 310 in at least one position. For example, the pawls 320 can secure the body 310 within the housing 230. Stated otherwise, the pawls 320 can secure the portion 330 within the housing 230. The pawls 320 can be coupled with the lever 315. For example, the pawls 320 can be mounted, secured, or attached to the lever 315. The lever 315 can move the pawls 320 from a position within the body 310 to a position that is external to the housing 230 (e.g., the pawls 320 escaped via the apertures 215).

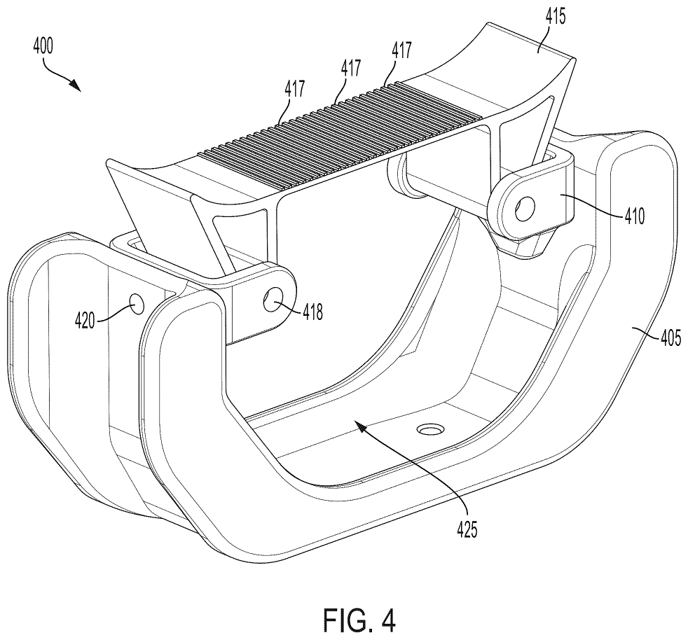

FIG. 4 depicts a perspective view of an apparatus 400. The apparatus 400 can include the apparatus described herein. The apparatus 400 can also include the attachment mechanism or the quick latch mechanism described herein. The apparatus 400 can couple with the vehicle 105. The apparatus 400 can couple with the vehicle 105 by at least one of attaching, mounting, securing, and/or connecting the apparatus 400 with the vehicle 105.

The apparatus 400 can include a body 405. The body 405 can couple with a mounting mechanism. For example, the body 405 can couple with a bike rack. The apparatus 400 can include an adjustment assembly 410. The adjustment assembly 410 can include at least one of a hinge, a pivot, a latch, or a frame. The adjustment assembly 410 can be coupled with the body 405. The adjustment assembly 410 can adjust an orientation of a surface 415 or an object receiving surface 415. For example, the adjustment assembly 410 can pivot, rotate, swing, or otherwise move to reorientate a position of the surface 415. The surface 415 can be coupled with the adjustment assembly 410. For example, the surface 415 can include a bracket or mount. To continue this example, the mount can be coupled with the adjustment assembly 410 via one or more fasteners. The surface 415 can receive one or more objects. For example, the surface 415 can receive a bike. The surface 415 can surround the objects. For example, the surface 415 can enclose or wrap at least partially around the bike responsive to the surface 415 receiving the bike. As another example, the surface 415 can move or otherwise adjust around an object as the object is placed on or interfaces with the surface 415.

The adjustment assembly 410 can include at least one aperture 418 or opening 418. The aperture 418 can receive at least a portion of the surface 415. For example, the aperture 418 can receive the mount of the surface 415. The aperture 418 can also receive a fastener to couple the adjustment assembly 410 with the surface 415. The adjustment assembly 410 can also include at least one aperture 420. The aperture 420 can receive at least one fastener. For example, the aperture 420 can receive a screw. The aperture 420 can receive a fastener to movably couple the adjustment assembly 410 with the body 405. For example, the adjustment assembly 410 can move, relative to the body 405, with the adjustment assembly 410 coupled with the body 405 via a fastener.

The surface 415 can include elastomer material. For example, the surface 415 can include a rubber material. As another example, the surface 415 can include material with elastic properties. The apparatus 400 can include at least one void 425 or opening 425. For example, the void 425 can include a space or an area. The void 425 can be disposed at least partially between the surface 415 and the body 405. For example, the void 425 can be located between the surface 415 and a bottom portion of the body 405. The void 425 can provide an area for one or more objects. For example, the void 425 can provide an area for a bike rack to occupy.

The surface 415 can include at least one protrusion 417. The protrusions 417 can engage with one or more objects. For example, the protrusions 417 can contact a frame of a bike. The protrusions 417 can prevent movement one the objects with respect to the body 405. For example, the protrusions 417 can increase a friction coefficient of the surface 415 which can limit or reduce movement of objects in contact with the protrusions 417.

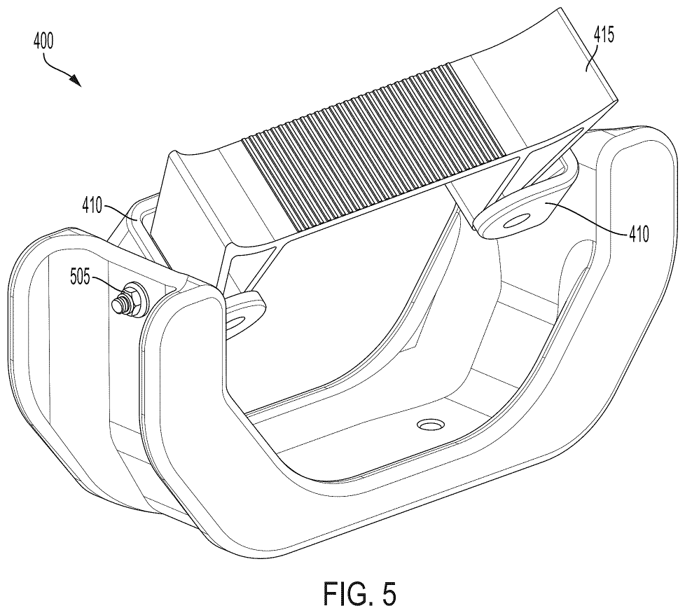

FIG. 5 depicts a perspective view of the apparatus 400. The aperture 420 can receive at least one fastener 505. The fasteners 505 can couple the adjustment assembly 410 with the surface 415. As shown in FIG. 5, the adjustment assembly 410 has adjusted an orientation of the surface 415. For example, the adjustment assembly 410 has rotated or moved the surface 415 to adjust the orientation of the surface 415. The adjustment assembly 410 can adjust the surface 415 to accommodate objects that have varying shape or orientation. For example, the adjustment assembly 410 can adjust the surface 415 to receive objects that are slanted or sloped. As another example, the adjustment assembly 410 can adjust the surface 415 to receive objects that uniform.

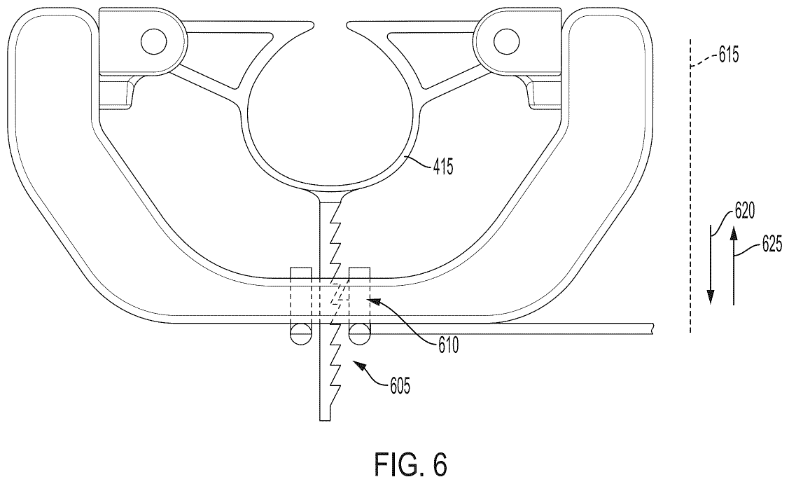

FIG. 6 depicts a perspective view of the apparatus 400. The apparatus 400 can include a locking mechanism 605. The locking mechanism 605 can allow movement of the surface 415. For example, the locking mechanism 605 can allow movement of the surface 415 in a first direction along an axis 615. As another example, the locking mechanism can allow movement of the surface 415 in direction 620. The locking mechanism 605 can prevent movement of the surface 415 in a second direction. For example, the locking mechanism can prevent movement of the surface 415 in direction 625.

The apparatus 400 can include a release mechanism 610. The release mechanism 610 can allow movement of the surface 415 in the second direction. For example, the release mechanism 610 can disengage from the locking mechanism 605 to allow movement of the surface 415. The release mechanism 610 can allow movement of the surface 415 to release the surface 415 from one or more objects. For example, the release mechanism 610 can allow for the surface 415 to move in the direction 625 to no longer surround the objects (e.g., release).

The surface 415 can move in one or more directions to receive one or more objects. For example, the surface 415 can move in the direction 620 to receive a bike. The surface 415 can move in one or more direction to release one or more objects. For example, the surface 415 can move in the direction 625 to release the bike.

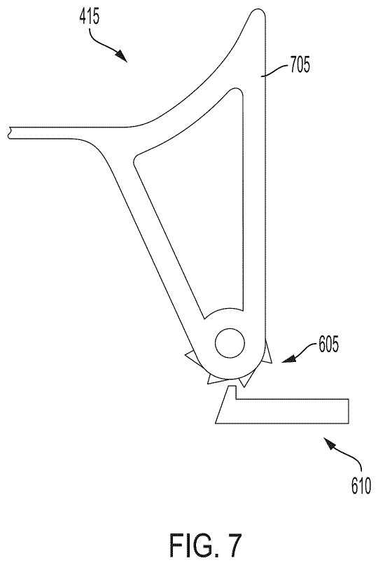

FIG. 7 depicts a perspective view of the apparatus 400. The apparatus 400 can include the locking mechanism 605 or ratchet 605. The ratchet 605 can be coupled with a mount 705 of the apparatus 400. The mount 705 can also be coupled with the adjustment assembly 410. The ratchet 605 can allow movement of the surface 415. For example, the ratchet 605 can allow for the surface 415 to move in a first direction. The ratchet 605 can prevent movement of the surface 415. For example, the ratchet 605 can prevent movement of the surface 415 in a second direction. The ratchet 605 can prevent movement of the surface 415 to lock or secure the surface 415 in one or more positions. For example, the ratchet 605 can prevent the surface 415 to move in the direction 625 responsive to the surface 415 having received an object.

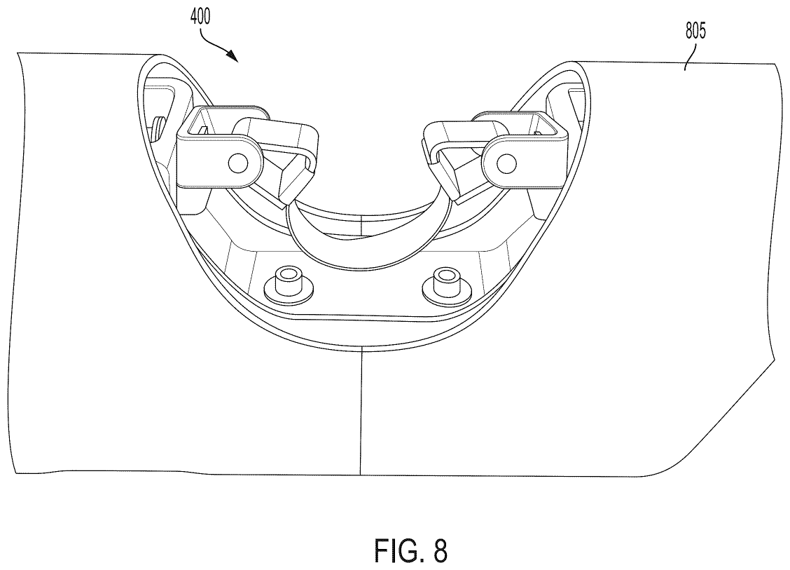

FIG. 8 depicts a perspective view of a mounting mechanism 805. As shown in FIG. 8, the apparatus 400 is coupled with a mounting mechanism 805. The mounting mechanism 805 can be included with or provided with the apparatus 400. The mounting mechanism 805 can be a bike rack. The mounting mechanism 805 can couple with a vehicle. For example, the mounting mechanism 805 can couple with the vehicle 105. The mounting mechanism 805 can couple one or more objects with the vehicle. For example, the mounting mechanism 805 can couple a bike with the vehicle 105 responsive to the surface 415 having received the bike.

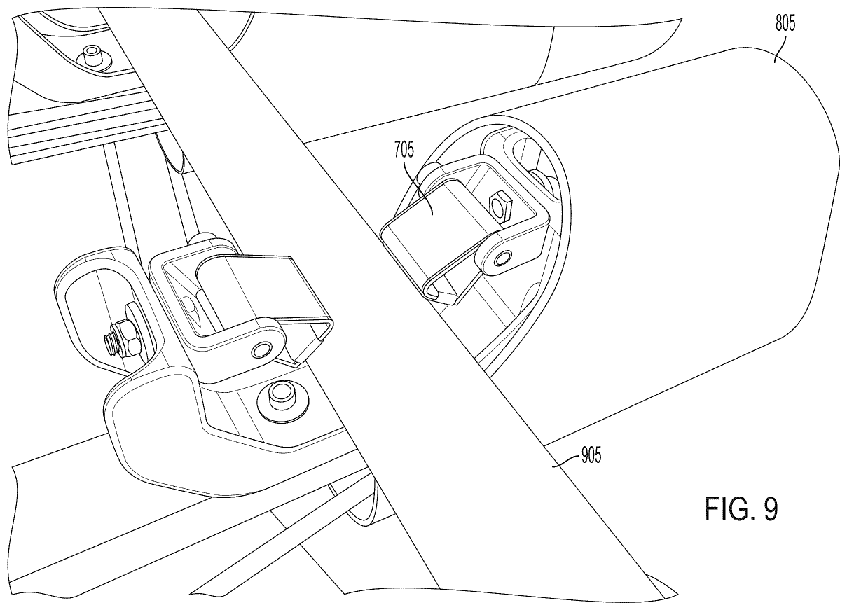

FIG. 9 depicts a perspective view of the mounting mechanism 805. As shown in FIG. 9, the surface 415 has received a frame of a bike 905 (e.g., an object). The mounting mechanism 805 can couple the bike 905 with the vehicle 105 responsive to the surface 415 having received the frame of the bike 905. For example, the mounting mechanism 805 can couple the bike 905 with the vehicle 105 responsive to the surface 415 having moved in the direction 620. As another example, the mounting mechanism 805 can couple the bike 905 with the vehicle 105 responsive to the surface 415 having at least partially surrounded the bike 905.

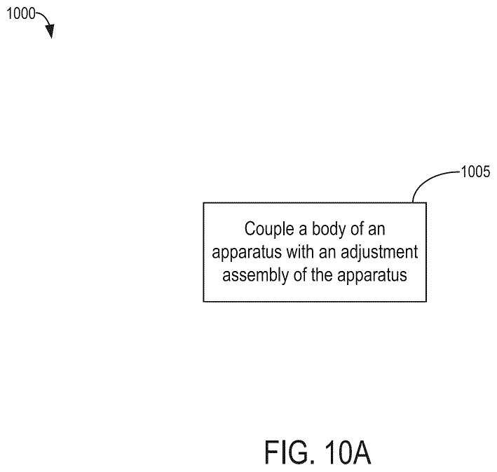

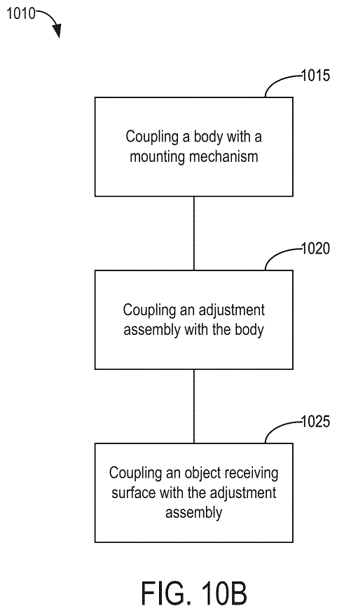

FIG. 10A depicts a block diagram of a process 1000 for manufacturing an apparatus. The apparatus can include the apparatus 400. The manufacturing of the apparatus 400 can include providing the apparatus 400. For example, the apparatus 400 can be provided during assembly of the vehicle 105. The apparatus 400 can also be provided responsive to the apparatus 400 having been purchased.

At act 1005, a body of an apparatus can be coupled with an adjustment assembly of the apparatus. For example, the body 405 can be coupled with the adjustment assembly 410. The body 405 can be coupled with the adjustment assembly 410 by at least one of mounting, attaching, securing, or attaching the body 405 with the adjustment assembly 410.

The body 405 can couple with the mounting mechanism 805. For example, the body 405 can be mounted to the mounting mechanism 805. The adjustment assembly 410 can adjust an orientation of the surface 415. For example, the adjustment assembly 410 can rotate or swivel the surface 415. The surface 415 can receive an object. For example, the surface 415 can receive a bike. The surface 415 can at least partially surround the object responsive to receipt of the object. For example, the surface 415 can abut or encircle at least a portion of the bike as the surface 415 receives the bike.

FIG. 10B depicts a block diagram of a process 1010 for manufacturing an apparatus. The apparatus can include the apparatus 400. The process 1010 can include the process 1000. The process 1010 can be separate from the process 1000.

At act 1015, a body can be coupled with a mounting mechanism. For example, the body 405 can be coupled with the mounting mechanism 805. The body 405 can be coupled with the mounting mechanism 805 by at least one of mounting, attaching, securing, affixing, or otherwise connecting the body 405 with the mounting mechanism 805. The mounting mechanism 805 can couple with the vehicle 105. For example, the mounting mechanism 805 can couple with the structural support attachment 205.

At act 1020, an adjustment assembly can be coupled with the body. For example, the adjustment assembly 410 can couple with the body 405. The adjustment assembly 410 can couple with the body 405 by at least one mounting, attaching, securing, affixing, or otherwise connecting the adjustment assembly 410 with the body 405. For example, the fasteners 505 can secure the adjustment assembly 410 to the body 405. As another example, the fasteners 505 can movably couple the adjustment assembly 410 with the body 405 (e.g., the adjustment assembly 410 can move, while coupled with the body 405, relative to the body 405).

At act 1025, an object receiving surface can be coupled with the adjustment assembly. For example, the surface 415 can couple with the adjustment assembly 410. The surface 415 can couple with the adjustment assembly 410 by at least one of mounting, attaching, securing, affixing, or otherwise connecting the surface 415 with the adjustment assembly 410. For example, a fastener can insert into the aperture 418 to couple the surface 415 with the adjustment assembly 410. The adjustment assembly 410 adjust an orientation of the surface 415. For example, the adjustment assembly 410 can rotate, spin, or swivel the surface 415 to adjust a placement or a position of the surface 415.

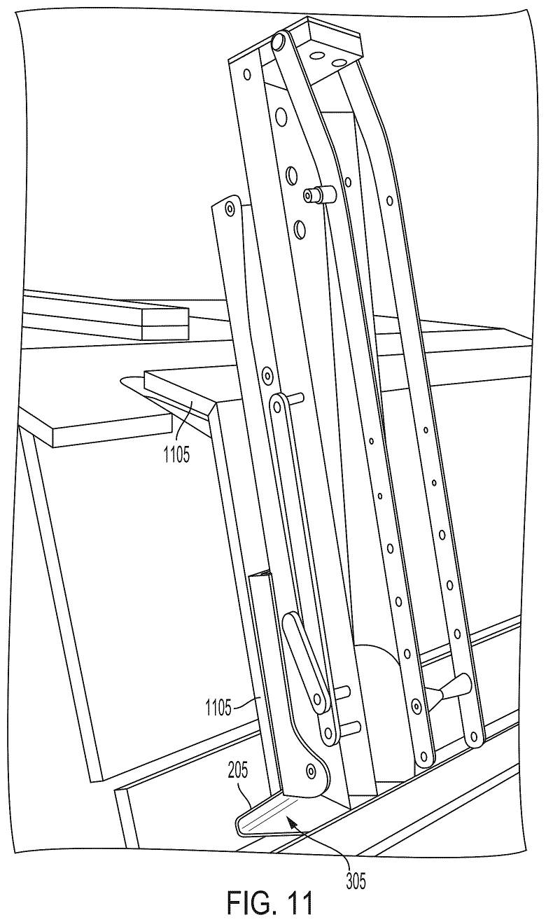

FIG. 11 depicts a perspective view of the vehicle 105. The vehicle 105 can include one or more structural support attachments 205. For example, the vehicle 105 can include a first structural support attachment 205 and a second structural support attachment 205. At least a portion of the structural support attachment 205 can be disposed within a rear gate of the vehicle 105. For example, the vehicle 105 can include a liftgate and at least a portion of the structural support attachment 205 can be disposed within the liftgate. FIG. 11 depicts an example of the structural support attachment 205 having at least a portion disposed within a rear gate of the vehicle 105.

The attachment mechanism 305 can include at least one portion 1105. For example, the attachment mechanism 305 can include a first portion 1105 and a second portion 1105. The portions 1105 can include one or more segments, sections, or structures. The first portion 1105 can couple with the structural support attachment 205. For example, the first portion 1105 can be attached, mounted, secured, or affixed to the structural support attachment 205. The first portion 1105 can couple with a first structural support attachment 205. For example, the first structural support attachment 205 can be disposed within a rear gate of the vehicle 105. To continue this example, the first portion 1105 can couple with the first structural support attachment 205. The second portion 1105 can couple with a second structural support attachment 205. For example, the second portion 1105 can be attached, mounted, secured, or affixed to the second structural support attachment 205. The second structural support attachment 205 can be superior to a rear window of the vehicle. For example, the second structural support attachment 205 can be located above the rear window of the vehicle 105.

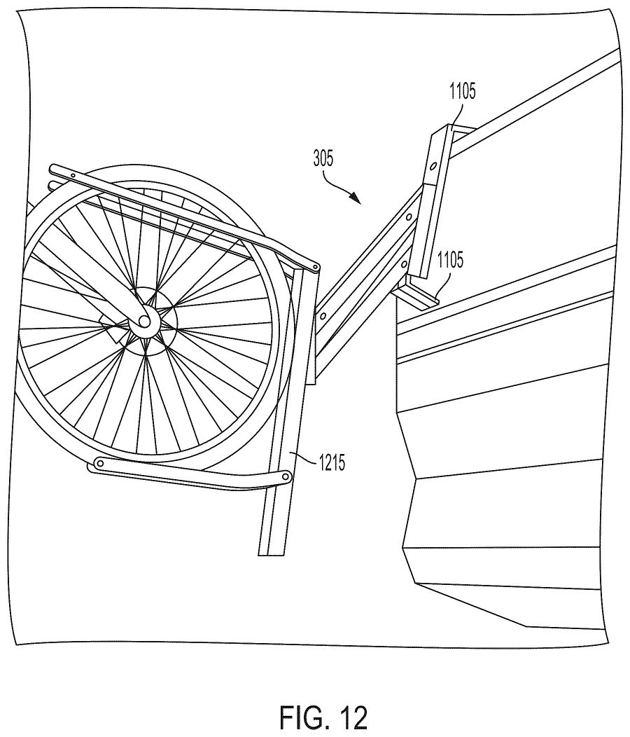

FIG. 12 depicts a perspective view of the vehicle 105. The vehicle 105 can include attachment mechanism 305. The attachment mechanism 305 can include the tray 1215. The tray 1215 can include one or more positions. For example, the tray 1215 can include a first position and a second position. The first position can include a deployed position. The second position can include a stowed position. FIG. 12 depicts an example of the tray 1215 in a deployed position. The tray 1215 can receive an object with the tray 1215 in the first position. For example, the tray 1215 can provide or serve as a ramp with the tray 1215 in the first position. The tray 1215 can stow the object with the tray 1215 in the second position. For example, the tray 1215 can secure a bicycle to the vehicle 105 with the tray 1215 in the stowed position.

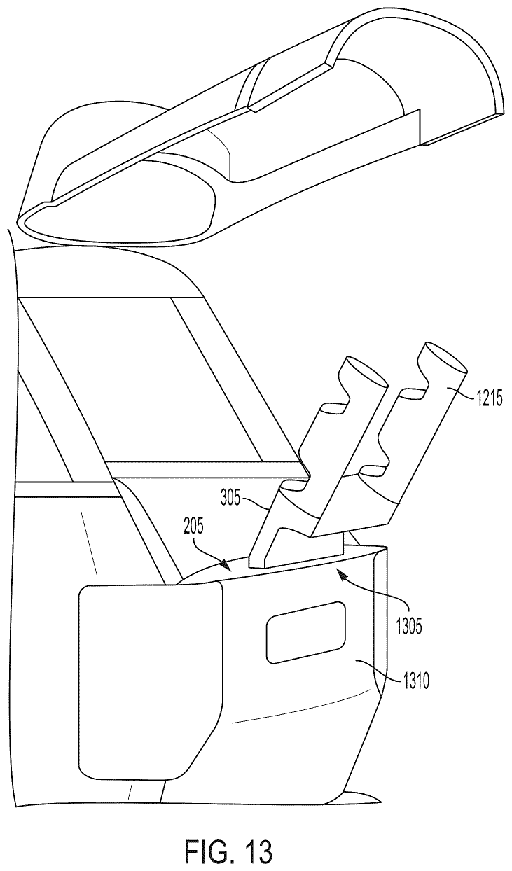

FIG. 13 depicts a perspective view of the vehicle 105. The vehicle 105 can include the structural support attachment 205. The structural support attachment 205 can include the attachment mechanism 305 and the tray 1215. For example, the attachment mechanism 305 and the tray 1215 can be provided with the structural support attachment 205. The structural support attachment 205 can be disposed within a portion of a rear gate 1310 of the vehicle 105. For example, the structural support attachment 205 can be disposed within a body of a lower portion of a split gate 1310. As another example, the rear gate may include a panel and the structural support attachment 205 can be disposed within the panel.

The apparatus 200 can include at least one adjustment assembly 1305. The adjustment assembly 1305 can be coupled with the structural support attachment 205. The adjustment assembly 1305 can couple the attachment mechanism 305 with the structural support attachment 205. The adjustment assembly 1305 can be disposed within a portion of a rear gate of the vehicle. For example, the adjustment assembly 1305 can be disposed within a panel of a lift gate for the vehicle 105. As another example, the adjustment assembly 1305 can be disposed within a lower portion of a split gate. The adjustment assembly 1305 can move the tray 1215. For example, the adjustment assembly 1305 can move the tray 1215 from a first position to a second position. The adjustment assembly 1305 can move the tray 1215 by at least one of rotating, spinning, swiveling, swinging, adjusting, or otherwise pivoting the tray 1215. The adjustment assembly 1305 can move the tray 1215 from a first position within a body of the vehicle 105 to a position external to the vehicle 105. FIG. 13 depicts an example of the adjustment assembly 1305 having moved the tray 1215 from a position within the body of the vehicle 105 to a position external to the vehicle 105.

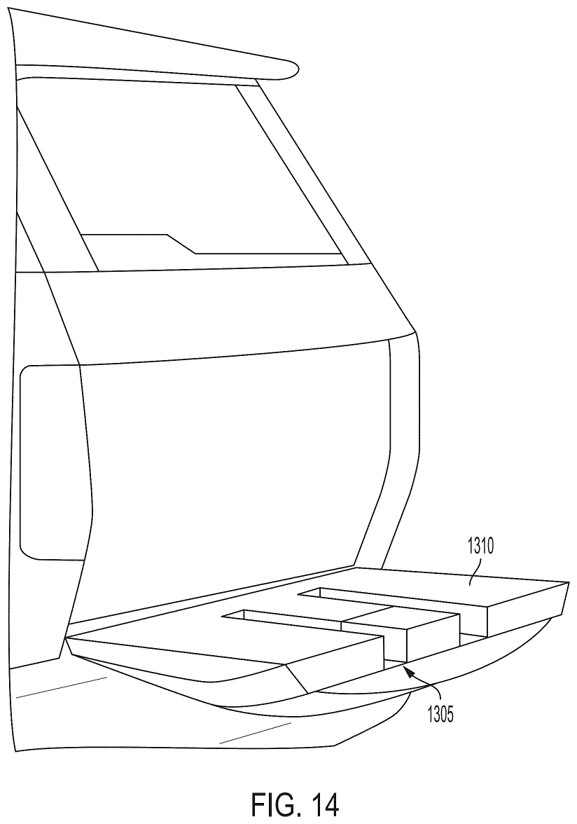

FIG. 14 depicts a perspective view of the vehicle 105. The adjustment assembly 1305 can be locked in one or more positions. For example, the adjustment assembly 1305 can be locked in a position within a body of the vehicle 105. As another example, the adjustment assembly 1305 can be locked in a position external to the vehicle. The adjustment assembly 1305 can be locked in a position within the rear gate 1310 of the vehicle 105. For example, the adjustment assembly 1305 can be locked in a deployed position within a lower portion of a split gate while the lower portion is coupled with an upper portion of the split gate. Stated otherwise, the adjustment assembly 1305 can be prevented from moving within the lower portion of the split gate coupled with the upper portion of the split gate. FIG. 14 depicts an example of the tray 1215 stowed within a body of a lower portion of a split gate of the vehicle 105.

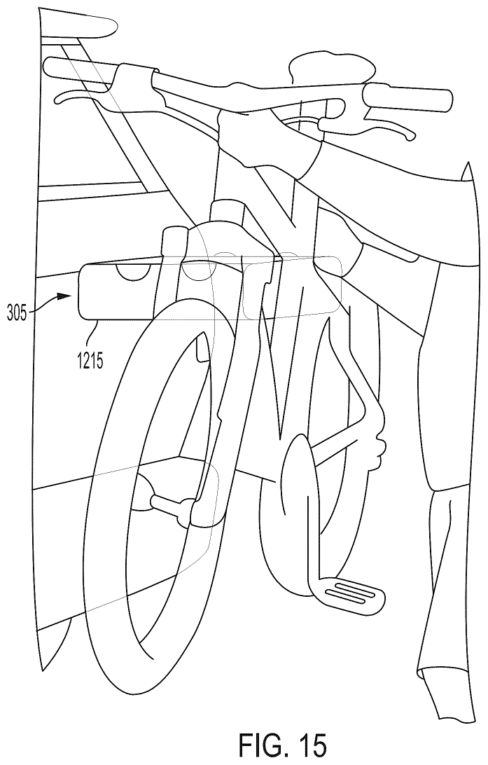

FIG. 15 depicts a perspective view of the vehicle 105. The attachment mechanism 305 can include the tray 1215. The tray 1215 can include one or more configurations. For example, the tray 1215 can include a first configuration and a second configuration. The tray 1215 can adjust from the first configuration to the second configuration. For example, the tray 1215 can be folded, collapsed, extended, deployed, or stowed to change from the first configuration to the second configuration. The tray 1215 can receive an object in a first configuration. For example, the tray 1215 can receive a bicycle in a deployed configuration. The tray 1215 can be stowed in a second configuration. For example, the tray 1215 can be stowed in the vehicle 105 with the tray 1215 in a folded or collapsed configuration. FIG. 15 depicts an example of the tray 1215 in a deployed configuration.

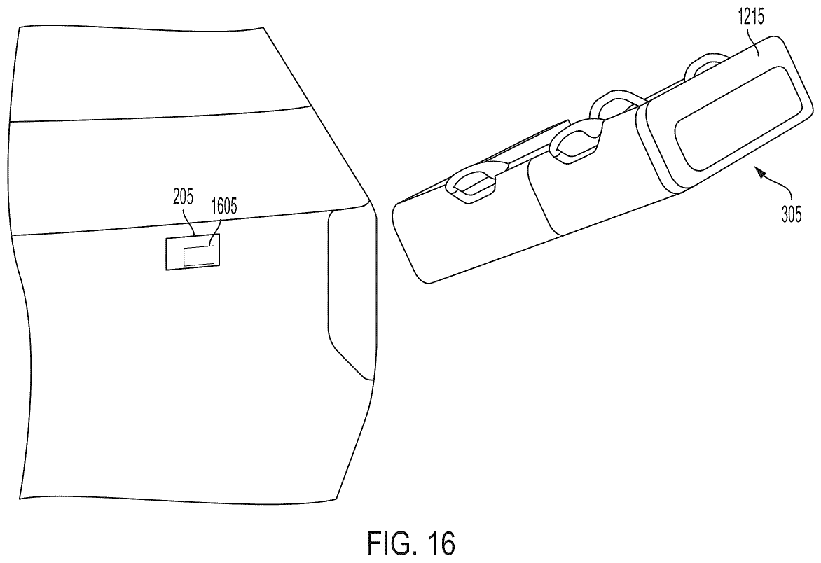

FIG. 16 depicts a perspective view of the vehicle 105. The attachment mechanism 305 can couple with the vehicle 105. For example, the vehicle 105 can include the structural support attachment 205 and the attachment mechanism 305 can couple with the structural support attachment 205. The structural support attachment 205 can include one or more ridges 1605 or slots 1605. At least a portion of the attachment mechanism 305 can be inserted into the ridges 1605. For example, ridges 1605 can receive at least a portion of the attachment mechanism 305.

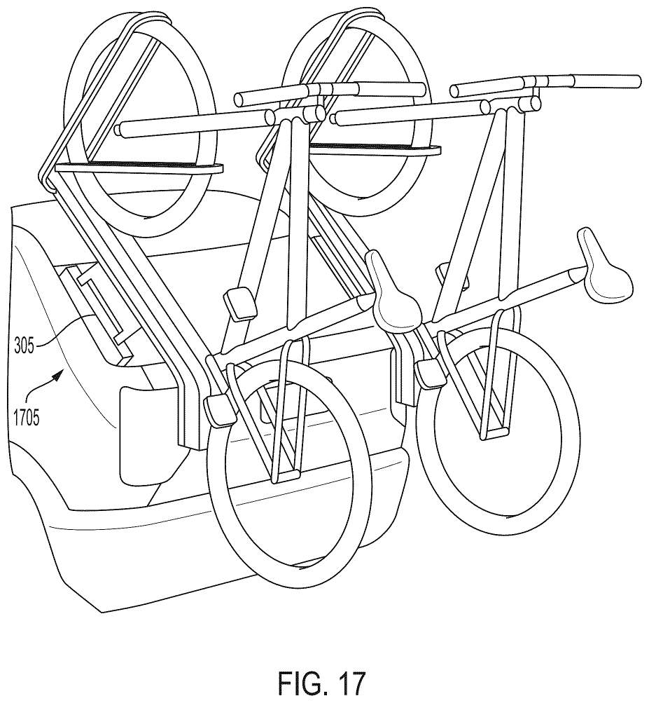

FIG. 17 depicts a perspective view of the vehicle 105. The vehicle 105 can include at least one pillar 1705. The structural support attachment 205 can couple with the pillar 1705. For example, the structural support attachment 205 can be mounted, attached, secured, or affixed to the pillar 1705. The attachment mechanism 305 can couple with the structural support attachment 205 to couple with the vehicle 105. For example, the attachment mechanism 305 can be coupled with the pillar 1705 via the structural support attachment 205. The attachment mechanism 305 can move from a first position to a second position. For example, the attachment mechanism 305 can move from a position at least partially behind the vehicle 105 to a position at least partially lateral to the vehicle 105. The attachment mechanism 305 can hold the tray 1215 in one or more positions. For example, the attachment mechanism 305 can hold the tray 1215 with the attachment mechanism 305 at least partially behind vehicle 105. As another example, the attachment mechanism 305 can hold the tray 1215 with the attachment mechanism 305 at least partially lateral to the vehicle 105.

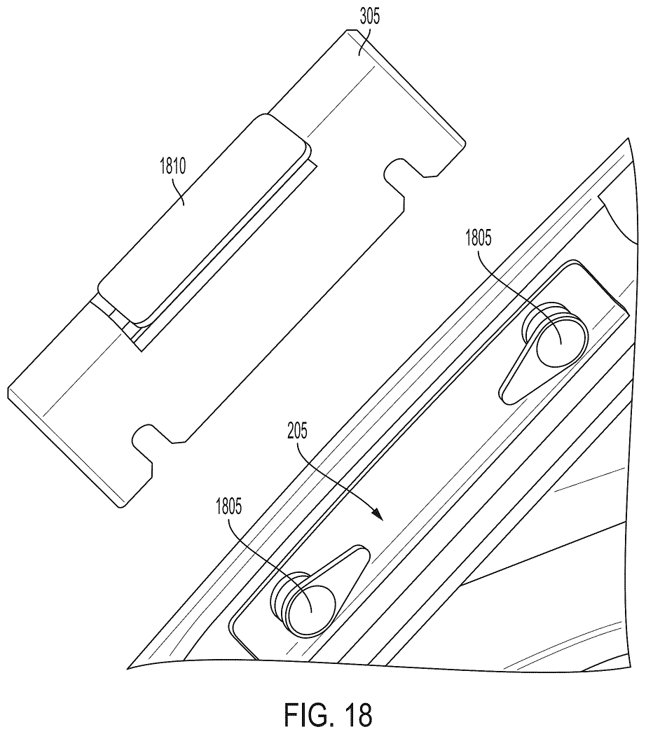

FIG. 18 depicts a perspective view of the vehicle 105. The structural support attachment 205 can include at least one mounting assembly 1805. The attachment mechanism 305 can couple with the mounting assembly 1805. The mounting assembly 1805 can couple the attachment mechanism 305 with the vehicle 105. The attachment mechanism 305 can include at least one platform assembly 1810. The tray 1215 can couple with the vehicle 105 via the platform assembly 1810. The platform assembly 1810 can rotate, spin, swivel, adjust, or move relative to a portion of the structural support attachment 205 or the pillar 1705.

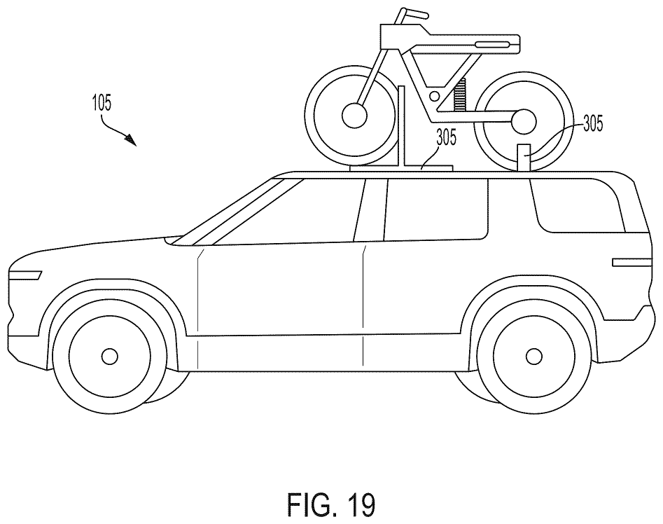

FIG. 19 depicts a perspective view of the vehicle 105. The vehicle 105 can include the attachment mechanism 305. The attachment mechanism 305 can be coupled with a top portion of the vehicle 105. For example, the attachment mechanism 305 can be coupled with a roof of the vehicle 105. As another example, the attachment mechanism 305 can be coupled with a crossbar of the vehicle 105. The bumper port 205 can be disposed or located within the top portion of the vehicle 105. For example, the bumper port 205 can be located within the roof of the vehicle 105. The bumper port 205 can couple the attachment mechanism 305 with the vehicle 105. For example, the bumper port 205 can receive the attachment mechanism 305. To continue this example, the bumper port 205 can secure the attachment mechanism 305 with the vehicle 105 with the attachment mechanism 305 inserted into the bumper port 205.

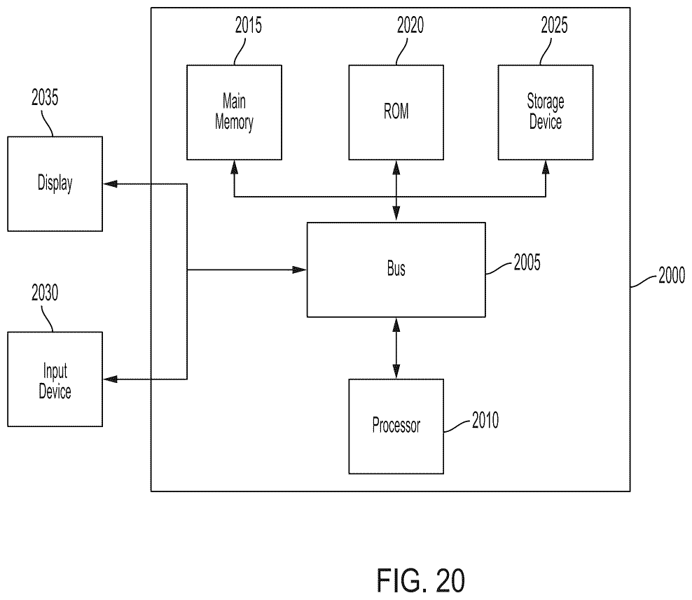

FIG. 20 depicts an example block diagram of an example computer system 2000. The computer system or computing device 2000 can include or be used to implement a data processing system or its components. The computing system 2000 includes at least one bus 2005 or other communication component for communicating information and at least one processor 2010 or processing circuit coupled to the bus 2005 for processing information. The computing system 2000 can also include one or more processors 2010 or processing circuits coupled to the bus for processing information. The computing system 2000 also includes at least one main memory 2015, such as a random access memory (RAM) or other dynamic storage device, coupled to the bus 2005 for storing information, and instructions to be executed by the processor 2010. The main memory 2015 can be used for storing information during execution of instructions by the processor 2010. The computing system 2000 may further include at least one read only memory (ROM) 2020 or other static storage device coupled to the bus 2005 for storing static information and instructions for the processor 2010. A storage device 2025, such as a solid state device, magnetic disk or optical disk, can be coupled to the bus 2005 to persistently store information and instructions.

The computing system 2000 may be coupled via the bus 2005 to a display 2035, such as a liquid crystal display, or active matrix display, for displaying information to a user such as a driver of the electric vehicle 105 or other end user. An input device 2030, such as a keyboard or voice interface may be coupled to the bus 2005 for communicating information and commands to the processor 2010. The input device 2030 can include a touch screen display 2035. The input device 2030 can also include a cursor control, such as a mouse, a trackball, or cursor direction keys, for communicating direction information and command selections to the processor 2010 and for controlling cursor movement on the display 2035.

The processes, systems and methods described herein can be implemented by the computing system 2000 in response to the processor 2010 executing an arrangement of instructions contained in main memory 2015. Such instructions can be read into main memory 2015 from another computer-readable medium, such as the storage device 2025. Execution of the arrangement of instructions contained in main memory 2015 causes the computing system 2000 to perform the illustrative processes described herein. One or more processors in a multi-processing arrangement may also be employed to execute the instructions contained in main memory 2015. Hard-wired circuitry can be used in place of or in combination with software instructions together with the systems and methods described herein. Systems and methods described herein are not limited to any specific combination of hardware circuitry and software.

Although an example computing system has been described in FIG. 20 the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a body configured to couple with a mounting mechanism;
an adjustment assembly configured to couple with the body, the adjustment assembly configured to adjust an orientation of an object receiving surface; and
the object receiving surface configured to couple with the adjustment assembly, the object receiving surface configured to:
receive an object; and
at least partially surround the object.

2. The apparatus of claim 1, comprising:
the object receiving surface including a plurality of protrusions configured to engage with the object; and
the plurality of protrusions configured to prevent movement of the object with respect to the body.

3. The apparatus of claim 1, comprising:
a locking mechanism configured to:
allow movement of the object receiving surface in a first direction; and
prevent movement of the object receiving surface in a second direction; and
a release mechanism to allow movement of the object receiving surface in the second direction to release the object receiving surface from the object.

4. The apparatus of claim 1, wherein the object is a bike, and comprising:
the mounting mechanism configured to:
couple with a vehicle; and
couple the bike with the vehicle.

5. The apparatus of claim 1, comprising:
the adjustment assembly including an aperture configured to receive at least a portion of the object receiving surface.

6. The apparatus of claim 1, comprising:
the object receiving surface configured to move in a first direction to receive the object; and
the object receiving surface configured to move in a second direction to release the object.

7. The apparatus of claim 1, wherein the object receiving surface includes an elastomer material.

8. The apparatus of claim 1, comprising:
the adjustment assembly including an aperture configured to receive a fastener to movably couple the adjustment assembly with the body.

9. The apparatus of claim 1, comprising:
a void disposed at least partially between the object receiving surface and a portion of the body; and
the void configured to provide an area for the object to occupy.

10. A vehicle, comprising:
an apparatus, comprising:
a body configured to couple with a mounting mechanism;
an adjustment assembly configured to couple with the body, the adjustment assembly configured to adjust an orientation of an object receiving surface; and
the object receiving surface configured to couple with the adjustment assembly, the object receiving surface configured to:
receive an object; and
at least partially surround the object responsive to receipt of the object.

11. The vehicle of claim 10, the apparatus comprising:
the object receiving surface including a plurality of protrusions configured to engage with the object; and
the plurality of protrusions configured to prevent movement of the object with respect to the body.

12. The vehicle of claim 10, the apparatus comprising:
a locking mechanism configured to:
allow movement of the object receiving surface in a first direction; and
prevent movement of the object receiving surface in a second direction; and
a release mechanism to allow movement of the object receiving surface in the second direction to release the object receiving surface from the object.

13. The vehicle of claim 10, wherein the object is a bike, and the apparatus further comprising:
the mounting mechanism configured to:
couple with the vehicle; and
couple the bike with the vehicle.

14. The vehicle of claim 10, the apparatus comprising:
the adjustment assembly including an aperture configured to receive at least a portion of the object receiving surface.

15. The vehicle of claim 10, the apparatus comprising:
the object receiving surface configured to move in a first direction to receive the object; and
the object receiving surface configured to move in a second direction to release the object.

16. The vehicle of claim 10, wherein the object receiving surface includes an elastomer material.

17. The vehicle of claim 10, the apparatus comprising:
the adjustment assembly including an aperture configured to receive a fastener to movably couple the adjustment assembly with the body.

18. The vehicle of claim 10, the apparatus comprising:
a void disposed at least partially between the object receiving surface and a portion of the body; and
the void configured to provide an area for the object to occupy.

19. The vehicle of claim 10, comprising:
a structural support attachment disposed within a top portion of the vehicle; and
an attachment mechanism configured to couple with the top portion of the vehicle via the structural support attachment.

20. A method, comprising:
coupling a body of an apparatus with an adjustment assembly of the apparatus, the body configured to couple with a mounting mechanism, and the adjustment assembly configured to adjust an orientation of an object receiving surface of the apparatus; and
the object receiving surface configured to:
receive an object; and
at least partially surround the object responsive to receipt of the object.
